(19) United States
(12) Patent Application Publication
(10) Pub. No.: US 2004/0037395 A1
(43) Pub. Date: Feb. 26, 2004

(54) Telephone apparatus

(76) Inventor: Kenichiro Itoh, Fukuoka (JP)

Correspondence Address: RATNERPRESTIA, P O BOX 980, VALLEY FORGE, PA, 19482-0980, US

(21) Appl. No.: 10/462,931

(22) Filed: Jun. 17, 2003

(30) Foreign Application Priority Data
Jun. 20, 2002 (JP) 2002-179564
Jun. 20, 2002 (JP) 2002-179565

(51) Int. Cl. H04M 1/64

(52) U.S. Cl. 379/67.1

(57) ABSTRACT

A telephone apparatus is capable of keeping previously received data as past incoming records, and making a callback telephone and/or returning a text message with a simple button-operation using a telephone number data contained in the past incoming records. The telephone apparatus stores received text messages in connection to their respective telephone numbers as incoming record data, and makes a call using a telephone number corresponding to a selected incoming record data as a calling address by pressing a call button while the selected incoming record data is displayed in a text message incoming record perusal mode. It also sets a forwarding address of a selected caller's identification data, and transmits a text message to the set address by pressing an incoming record search button after completion of inputting the text message in a text message transmission mode.

### TECHNICAL FIELD

The present invention relates to a telephone apparatus having functions of receiving text messages through a phone-line interface and storing the same.

### BACKGROUND OF THE INVENTION

There has been an increased popularity in recent years for use of SMS (“Short Mail Services”) for transmitting and receiving text messages with telephone apparatuses.

Japanese Patent Unexamined Publication No. 1988-217850, for example, discloses a method of automatically setting a data on telephone number of a party transmitting an e-mail and the like, in a form suitable to the other party to whom the e-mail and the like are addressed, based on a telephone number of the other party. The publication states that the method allows the mail-receiving party to use the transmitted data, as received, as a telephone number to make a call or return a response thereto.

In addition, Japanese Patent Unexamined Publication No. 2002-305605 discloses a portable telephone with capability that upon receipt of a mail, a receiving party can easily identify a telephone number of a transmitting party of the mail, and call back the transmitting party to exchange vocal communication. This publication describes a technique that a keyword is included in a text message area of the mail to identify the transmitting party desiring a call-back when the mail is transmitted, the receiving party detects and store the keyword upon arrival of each mail, compares the keyword of the transmitting party with those stored in the telephone, retrieves a telephone number corresponding to one of the keywords that matches, and uses it to dial, thereby making a return-call easy.

This technique of the prior art has a problem, however, that the party making a call is required to register the keyword for the other party to be dialed, which is not useful unless a person is familiar with details of it. Moreover, there has not been any telephone capable of making a callback with a simple operation even if previously received data are kept stored as past incoming records.

### SUMMARY OF THE INVENTION

The present invention addresses the above problems of the prior art, and it is an object of this invention to provide a telephone apparatus which is capable of keeping previously received data as past incoming records, and making a callback telephone and/or returning a text message with a simple button-operation using a telephone number data contained in the past incoming records.

A telephone apparatus of this invention accomplishes the above object with a structure, which comprises a text message incoming record storage for storing a text message received via a phone-line interface and a telephone number corresponding to the received text message as incoming record data corresponding thereto, and call back means for making a call to a telephone number corresponding to an incoming record data selected in a perusal mode for text message incoming records, when a call button is pushed while the selected incoming record data is being displayed. Accordingly, there is provided the telephone apparatus capable of making a callback telephone and/or responding with a text message using the telephone number contained in the received text message.

### BRIEF DESCRIPTION OF THE DRAWINGS

FIG. 1 is a block diagram illustrating a telephone apparatus according to a first exemplary embodiment of the present invention.

FIG. 2 is a functional block diagram illustrating a configuration of controller implemented by software.

FIG. 3 is a flow chart showing an operation of the telephone apparatus illustrated in FIG. 1 and FIG. 2.

FIG. 4 is a block diagram illustrating a telephone apparatus according to a second exemplary embodiment of the invention.

FIG. 5 is a functional block diagram illustrating a configuration of controller shown in FIG. 4 implemented by software.

FIG. 6 is a flow chart showing an operation of the telephone apparatus illustrated in FIG. 4 and FIG. 5.

### DETAILED DESCRIPTION

Description is provided hereinafter of exemplary embodiments of the present invention with reference to the accompanying drawings.

(First Exemplary Embodiment)

Referring now to the drawings, an exemplary embodiment of this invention is described hereinafter.

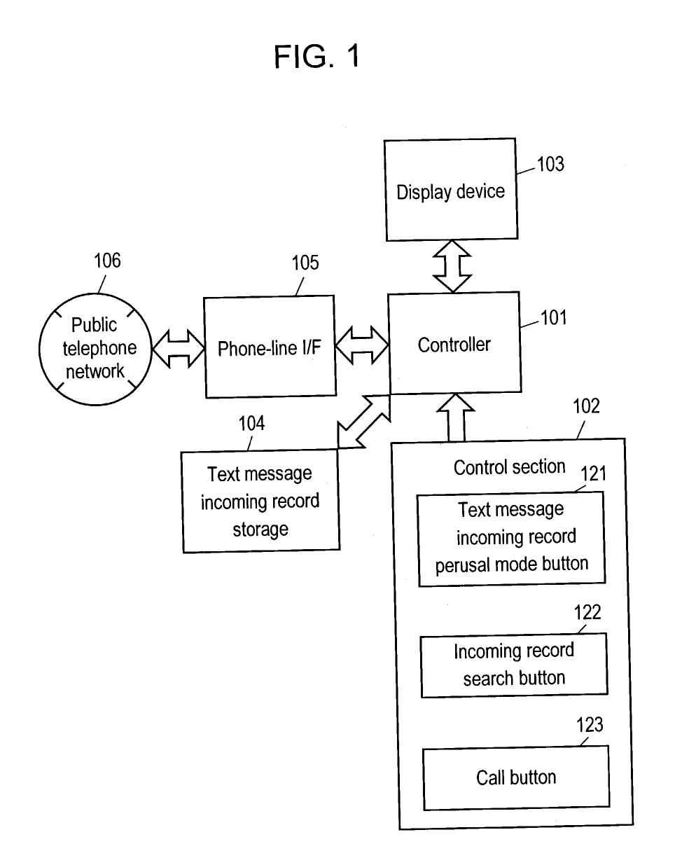

Shown in FIG. 1 are controller 101 for controlling an apparatus entirely, control section 102 for entry of data and the like input, display device 103 for displaying texts and graphic symbols, text message incoming record storage 104 for storing, as an incoming record data, a caller's identification number received via phone-line interface (“phone-line I/F”) 105 and a telephone number corresponding thereto, and public telephone network 106 in connection through phone-line I/F 105. Furthermore, control section 102 comprises text message incoming record perusal mode button (“record perusal button”) 121 for shifting to a text message incoming record perusal mode, incoming record search button 122 for searching for an incoming record data, and call button 123 for initiating a call.

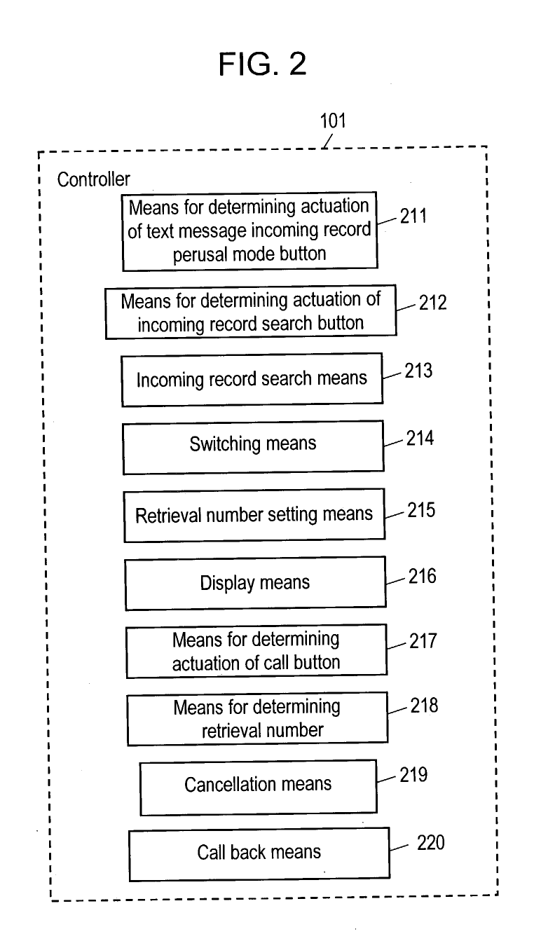

FIG. 2 illustrates a configuration of controller 101. Means 211 for determining actuation of text message incoming record perusal mode button (“record perusal determination means”) determines whether record perusal button 121 on control section 102 is pressed. Means 212 for determining actuation of incoming record search button (“record search determination means”) determines whether incoming record search button 122 is pressed. Incoming record search means 213 determines presence or absence of any incoming record data when the above determinations are that record perusal button 121 and incoming record search button 122 are pressed. Switching means 214 shifts to the text message incoming record perusal mode when an incoming record data is determined as present. Retrieval number setting means 215 sets a retrieval number in a sequential order upon shifting to the text message incoming record perusal mode. Display means 216 displays a text message and a telephone number, as an incoming record data corresponding to the retrieval number set in the sequential order. Means 217 for determining actuation of call button (“call determination means”) determines whether call button 123 on control section 102 is pressed while the incoming record data is displayed. Means 218 for determining retrieval number determines whether a retrieval number exceeds a given number (i.e. the largest of retrieval numbers). Cancellation means 219 cancels the text message incoming record perusal mode. Call back means 220 connects a call to a party by dialing the telephone number shown in the displayed incoming record data, when call button 123 is determined pressed.

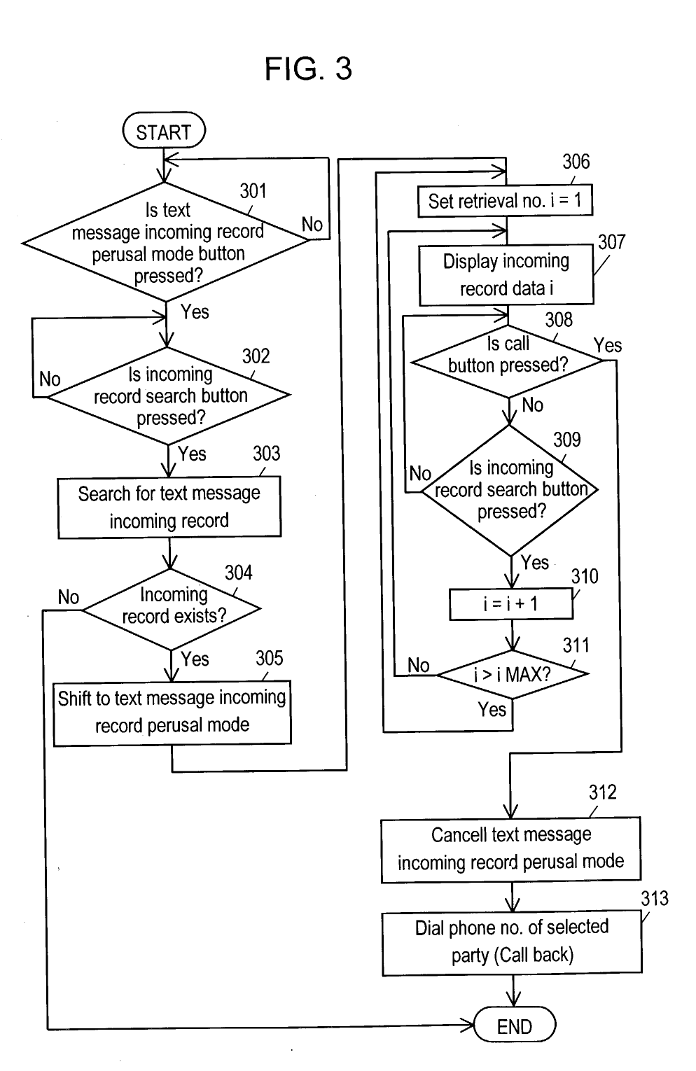

The telephone apparatus constructed as above operates in a manner, which is described with reference to FIG. 3. FIG. 3 is a flow chart showing an operation of the telephone apparatus illustrated in FIG. 1 and FIG. 2. In step 301, record perusal determination means 211 determines whether record perusal button 121 on control section 102 is pressed. When it determines that record perusal button 121 is pressed, record search determination means 212 then determines whether incoming record search button 122 is pressed, in step 302. When it determines that button 122 is pressed, incoming record search means 213 searches for any text message incoming record, in step 303. Determination is also made, in step 304, as to if there exists any incoming record data containing a text message and a telephone number. When the determination results in presence of an incoming record data, switching means 214 shifts the processing mode into a text message incoming record perusal mode, in step 305. In step 306, retrieval number setting means 215 sets retrieval number “i” in a sequential order for retrieval of the incoming record data. The number is set first as “i”=1. In step 307 display means 216 displays a text message and a telephone number corresponding to the retrieval number “i”, one after another, in display device 103. In step 308, an operator determines whether the telephone number corresponding to the presently displayed retrieval number “i” is the number he/she desires to call. When the operator determines it as the telephone number to be called, he/she pushes call button 123. Otherwise, he/she pushes incoming record search button 122 again. When record search determination means 212 determines that incoming record search button 122 is pressed, in step 309, retrieval number setting means 215 increases the retrieval number “i” by one (i.e. “i”=“i”+1) in step 310. This process of increasing the retrieval number “i” by one at a time is continued as long as call button 123 is not pressed, and until retrieval number determination means 218 determines in step 311 that retrieval number “i” exceeds a given number iMAX (the largest of retrieval numbers). In other words, the steps 307 to 310 are repeated. The process goes back to step 306 when retrieval number determination means 218 determines that the retrieval number reached “i”>iMAX.

In step 308, when call determination means 217 determines that call button 123 is pressed as the operator finds any of the desired text message and telephone number among the incoming record data in display, cancellation means 219 cancels the text message incoming record perusal mode in step 312. Finally, in step 313, call back means 220 sets the telephone number corresponding to the incoming record data, which is displayed at the time the call button is detected pressed, i.e. a telephone number of a sender of the text message, as an address to be called back, and transmits to the public network a data representing the call address according to the telephone number data. A telephone communication is thus started upon reception of a signal conveying line connection through public telephone network 106.

The telephone apparatus according to the first exemplary embodiment has such advantages as described hereinafter.

The telephone apparatus discussed in this exemplary embodiment has call back means 220 for making a call using a telephone number corresponding to a selected incoming record data as a call address, when the call button is pressed while the selected incoming record data is displayed in the text message incoming record perusal mode. Accordingly, it stores received incoming record data, i.e. received text message and telephone number, in connection with a retrieval number, and uses the stored incoming record data when necessary as a call address to make a callback telephone. In short, the telephone apparatus can make the callback telephone using the telephone number in the received text message, thereby expediting a connection to the call-receiving party.

The telephone apparatus of this invention further comprises incoming record search means 213 for determining presence or absence of an incoming record data, switching means 214 for shifting into a text message incoming record perusal mode when an incoming record data is determined to be present in the step of determining presence or absence of the incoming record data, retrieval number setting means 215 for setting a retrieval number in a sequential order in the text message incoming record perusal mode, display means 216 for displaying a text message and a telephone number, as an incoming record data corresponding to the retrieval number set in the sequential order, call determination means 217 for determining whether call button 123 is pressed while the incoming record data is displayed, and call back means 220 for initiating a call to a party of the telephone number shown in the incoming record data in display when call button 123 is determined pressed. This configuration provides functions of: (1) storing the incoming record data received therein, i.e. the text message and the telephone number, in a manner to correlate with the retrieval number; (2) displaying the stored text message and telephone number in a sequential order; and (3) making a callback to a telephone number of any desired party by pressing call button 123 when the desired text message and telephone number are found. Because of these functions, the telephone number in the received text message can be used to make a callback telephone, thereby expediting a connection to the call-receiving party.

The telephone apparatus of this invention further comprises record perusal determination means 211 for determining whether record perusal button 121 on control section 102 is pressed, record search determination means 212 for determining whether incoming record search button 122 on control section 102 is pressed, and incoming record search means 213 for determining presence or absence of an incoming record data when record perusal button 121 and incoming record search button 122 are determined pressed. They enable the telephone apparatus to ensure searching of the incoming record data as to whether it is present or absent. The telephone apparatus can then shift to the text message incoming record perusal mode properly when it determines presence of the incoming record data as a result of the search.

In addition, a program to carry out the individual steps of the method of making telephone call in FIG. 3 can be recorded in a recording medium, which allows use of a general-purpose computer to execute the program of FIG. 3 at any place and any time.

(Second Exemplary Embodiment)

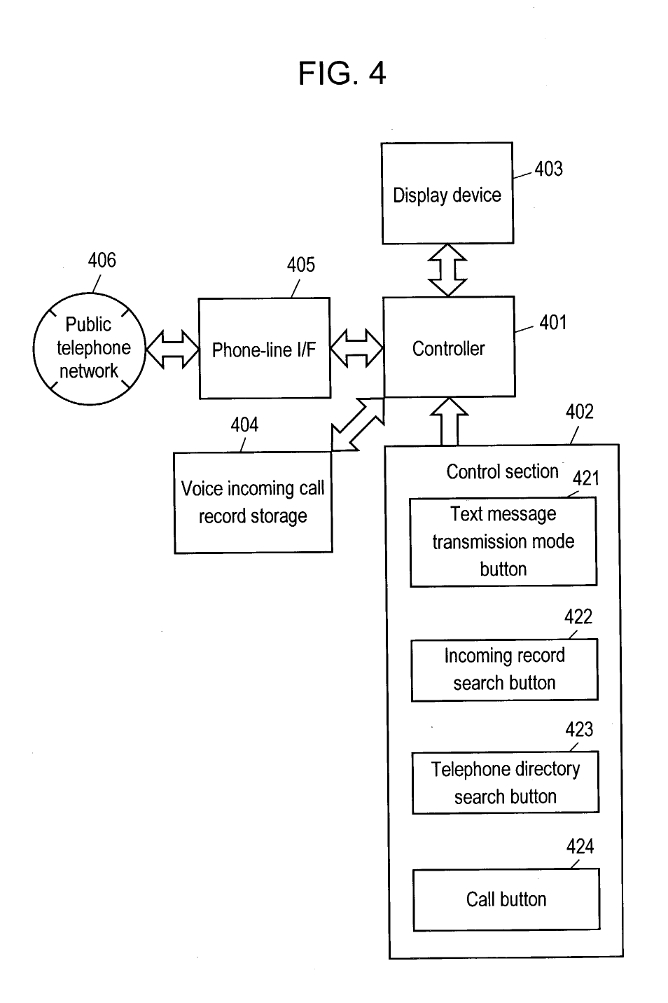

A telephone apparatus representing a second exemplary embodiment of this invention is described now with reference to FIG. 4 through FIG. 6. The telephone apparatus of the second exemplary embodiment comprises controller 401 for controlling the entire apparatus, control section 402 for entry of data and the like input, display device 403 for displaying texts and graphic symbols, incoming-call record storage (“voice call record storage”) 404 for storing, as incoming-call record data, a caller's identification data such as a telephone number received via phone-line I/F 405, and phone-line I/F 405 in connection with public telephone network 406. Control section 402 comprises text message transmission mode button (“transmission button”) 421 for shifting into a text message transmission mode, incoming record search button 422 to search for an incoming-call record data, telephone directory search button (telephone directory button) 423 to search for a telephone directory data, and call button 424 for initiating a call.

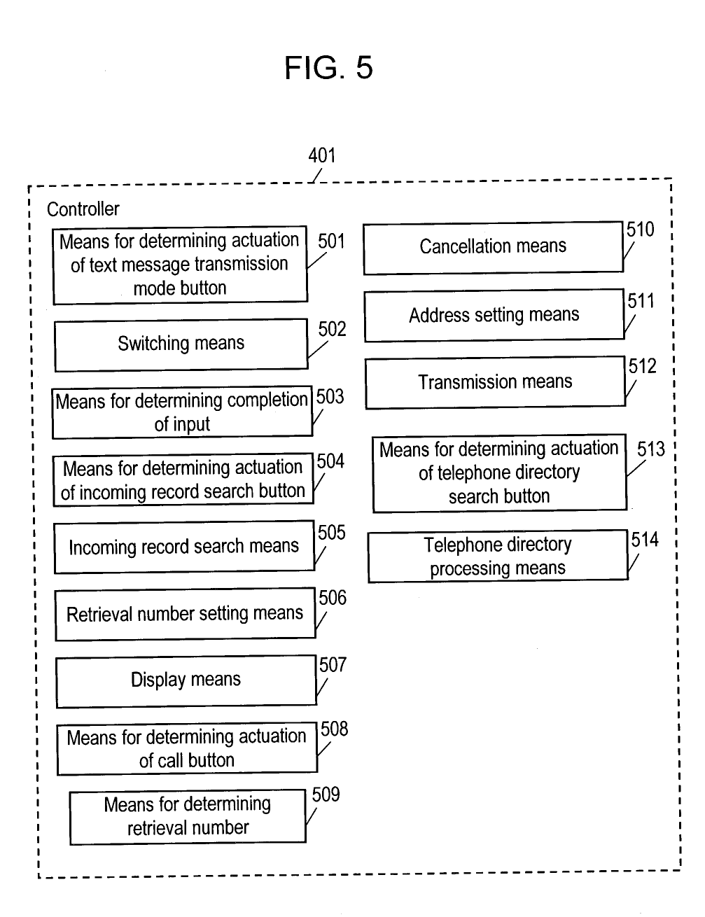

Controller 401 can be implemented by software, and it has individual means shown in FIG. 5. Description is now provided of these means as follows.

Means 501 for determining actuation of text message transmission mode button (“transmission determination means”) determines whether transmission button 421 is pressed. Switching means 502 shifts to the text message transmission mode when transmission button 421 is pressed, and it then shifts to a standby state for entry of an address input upon completion of inputting a text message. Means 503 for determining completion of input determines whether input of a text message is completed in the text message transmission mode. Means 504 for determining actuation of incoming record search button (“incoming record search determination means”) determines whether incoming record search button 422 is pressed. Incoming record search means 505 searches for an incoming-call record data and determines presence or absence of any incoming-call record data when button 422 is determined pressed. Retrieval number setting means 506 sets a retrieval number in a sequential order for retrieving the incoming-call record data when the incoming-call record data is determined present in the process of determining presence or absence of the incoming-call record data. Display means 507 displays a caller's identification data corresponding to the retrieval number set in the sequential order in display device 403. Means 508 for determining actuation of call button (“call determination means”) determines whether call button 424 is pressed, as is the case when a desired caller's identification data is present among the data displayed. Means 509 for determining retrieval number determines whether the retrieval number being searched exceeds a given number. Cancellation means 510 cancels the text message transmission mode and/or the standby state for address entry. Address setting means 511 sets the caller's identification data shown in the incoming-call record data when call button 424 is pressed. Transmission means 512 transmits the text message to the addressed party designated by the caller's identification data. When incoming record search button 422 is determined not pressed, means 513 for determining actuation of telephone directory search button (telephone directory determination means) determines whether telephone directory search button 423 is pressed. Telephone directory processing means 514 retrieves a selected telephone directory data and transmits the text message to a telephone number shown in the telephone directory data when telephone directory search button 423 is pressed.

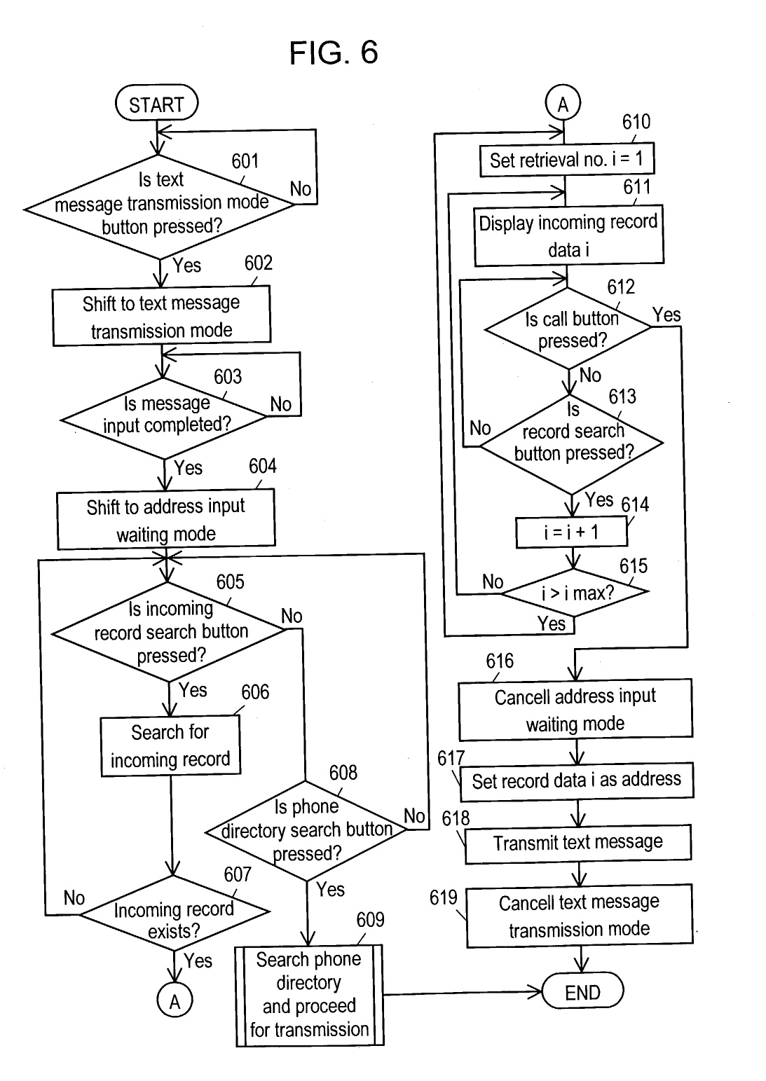

The telephone apparatus constructed as above operates in a manner, which is described with reference to FIG. 6. In step 501, transmission determination means 501 determines whether transmission button 421 is pressed. When transmission button 421 is pressed, the process proceeds to step 602 in which switching means 502 shifts the processing mode to the text message transmission mode. In the next step 603, means 503 for determining completion of input determines whether input of text message is completed in the text message transmission mode. When the input of text message is determined completed, switching means 502 shifts the processing mode to a standby state waiting for input of an address, in step 604. In step 605, incoming record search determination means 504 determines whether incoming record search button (“record search button”) 422 on control section 402 is pressed. When record search button 422 is pressed, the process proceeds to step 606 in which incoming record search means 505 searches through incoming-call record data, and continues to determine presence or absence of the incoming-call record data in step 607. The process goes back to step 605 when incoming-call record data is found not exists.

When an incoming-call record data is determined present in step 607, the process proceeds to step 610 in which retrieval number setting means 506 sets retrieval number “i” in a sequential manner for retrieval of the incoming-call record data. In this step 610, the first number is set as “i”=1. In step 611, display means 507 displays in display device 403 a caller's identification data corresponding to the retrieval number “i” set in the sequential order. In step 612, the operator pushes call button 424 when he/she determines to call the address (i.e. a telephone number corresponding to the retrieval number “i”) displayed in display device 403. Otherwise, the operator pushes incoming record search button 422 to continue displaying the next caller's identification data. When incoming record search determination means 504 determines that record search button 422 is pressed in step 613, the process proceeds to step 614 in which retrieval number setting means 506 increases the retrieval number “i” by one (i.e. “i”=“i”+1). This process of increasing the retrieval number “i” by one at a time is continued so long as call button 424 is not pressed, and until retrieval number determination means 509 determines in step 615 that retrieval number “i” exceeds a given number iMAX (the largest of retrieval numbers). The process goes back to step 610 when determination means 509 determines that the retrieval number reached “i”>iMAX.

When there is a desired displayed caller's identification data among the caller's identification data in the display, and call determination means 508 determines that call button 424 is pressed in step 612, the process goes on to step 616 in which cancellation means 510 cancels the standby state for address entry. In the following step 617, address setting means 511 sets a telephone number provided in the incoming-call record data (i.e. a telephone number in the incoming-call record data represented by the retrieval number “i” shown at the time) as an forwarding address of the text message. A data representing the forwarding address is then transmitted to public telephone network 406 according to the telephone number data. Transmission means 512 transmits the text message in step 618, when it receives a signal conveying completion of line-connection through public telephone network 406. Upon completion of transmitting the text message, cancellation means 510 cancels the text message transmission mode in step 619, which ends this process.

When incoming record determination means 504 determines in step 605 that record search button 422 is not pressed, the process proceeds to step 608, and telephone directory determination means 513 determines whether telephone directory search button 423 is pressed. When telephone directory search button 423 is pressed, the process proceeds to step 609, in which telephone directory processing means 514 searches through the telephone directory data. When telephone directory processing means 514 finds a desired telephone number in the telephone directory data, it transmits the text message using the desired telephone number as the forwarding address, and ends the process. If telephone directory determination means 513 determines that telephone directory search button 423 is not pressed, the process goes back to step 605.

The telephone apparatus according to the second exemplary embodiment has advantages, which are described hereinafter.

The telephone apparatus as discussed in the second exemplary embodiment comprises phone-line I/F 405 connected with public telephone network 406, incoming-call record storage 404 for storing a caller's identification data received via phone-line I/F 405 as an incoming-call record data, control section 402 for entry of data and the like input, display device 403 for displaying texts and graphic symbols, and controller 401 for controlling the entire apparatus. Aslo, controller 401 has address setting means 511 and transmission means 512. Address setting means 511 sets a telephone number shown in a incoming-call record data as a forwarding address, when incoming record search button 422 on control section 402 is pressed and the incoming-call record data is available after completion of inputting a text message in the text message transmission mode. Transmission means 512 then transmits the text message to the address of the set telephone number. Because of the configuration as described, the telephone apparatus can store the caller's information it receives as the caller's identification data, read out and use it as a forwarding address of the text message whenever necessary. The received caller's information can be thus used effectively, and expedite transmission of text messages.

Moreover, in the telephone apparatus of the second exemplary embodiment, controller 401 comprises incoming record search determination means 504 for determining whether incoming record search button 422 on control section 402 is pressed, after completion of inputting a text message in the text message transmission mode, incoming record search means 505 for determining presence or absence of an incoming-call record data when button 422 is pressed, retrieval number setting means 506 for setting a retrieval number in a sequential order when the incoming-call record data is determined present in the process of determining presence or absence of the incoming-call record data, display means 507 for displaying a caller's identification data corresponding to the retrieval number set in the sequential order, call determination means 508 for determining whether call button 424 on control section 402 is pressed, as is the case when a desired caller's identification data is present among the caller's identification data displayed, address setting means 511 for setting the caller's identification data shown in the incoming-call record data when call button 424 is pressed, and transmission means 512 for transmitting the text message to an address of the set telephone number. This configuration enables the telephone apparatus to perform the following functions: (1) storing the caller's identification data as caller's information; (2) displaying the stored caller's identification data and telephone number in a sequential order; and (3) transmitting a text message, when a desired caller's identification data is found, using the desired caller's identification data as a forwarding address, by pressing the call button. In other words, the incoming caller's identification data can be used effectively by showing it in display, thereby expediting the transmission of text messages.

Furthermore, controller 401 has transmission determination means 501, switching means 502, and input completion determination means 503. In this embodiment here, transmission determination means 501 determines whether transmission button 421 on control section is pressed. Switching means 502 shifts to the text message transmission mode when transmission button 421 is pressed. Input completion determination means 503 determines whether input of a text message is completed in the text message transmission mode. This configuration realizes shifting to the text message transmission mode smoothly, and ensures input of text message with certainty.

In addition, controller 401 has incoming record search determination means 504, telephone directory determination means 513, and telephone directory processing means 514, in the telephone apparatus of this invention. Here, incoming record search determination means 504 determines whether record search button 422 on control section 402 is pressed, after completion of inputting a text message in the text message transmission mode. Telephone directory determination means 513 determines whether telephone directory search button 423 is pressed. Telephone directory processing means 514 searches through the telephone directory data when telephone directory search button 423 is pressed, and transmits text message to the telephone number shown in the selected telephone directory data. Since this configuration provides an alternative in which search of the caller's information can be switched to the telephone directory data if the data is determined not present in the incoming-call record data. It can thus increase a possibility of obtaining a telephone number of the desired forwarding address.

Moreover, a program to carry out the individual steps of the method of making telephone communication in FIG. 6 may be recorded in a recording medium, thereby allowing use of a general-purpose computer to execute the program of FIG. 6 at any place and any time.

What have been discussed above are the telephone apparatus in the first exemplary embodiment, which uses received incoming-call record data, i.e. received text message and telephone number stored in connection with the retrieval number, and another telephone apparatus in the second exemplary embodiment, which uses received caller's identification data such as telephone number and the like stored as incoming-call record data.

The present invention can provide the telephone apparatus with capability of storing the previously received data as incoming record data, and making a callback telephone and/or returning a text message with a simple button-operation by using the telephone number data contained in the incoming record data.

What is claimed is:

1. A telephone apparatus having a function of communicating a text message via a phone-line interface, said telephone apparatus comprising:
said phone-line interface in connection with public telephone network;
a text message incoming record storage for storing a text message received via said phone-line interface and a telephone number corresponding to the received text message as incoming record data corresponding thereto;
a control section for entry of data input;
a display device; and
a controller
wherein said controller makes a call to a telephone number as a call address corresponding to the selected incoming record data when a call button is pressed while a selected one of the incoming record data is displayed.

2. The telephone apparatus of claim 1 wherein
said storage stores the text message and the telephone number in connection with a retrieval number used for retrieving incoming record data, and
said controller further comprises:
incoming record search means for determining presence or absence of the incoming record data;
switching means for shifting to a text message incoming record perusal mode when the incoming record data is determined present;
retrieval number setting means for setting the retrieval number in a sequential order in the text message incoming record perusal mode;
display means for displaying the text message and the telephone number as the incoming record data corresponding to the retrieval number set in the sequential order;
means for determining actuation of a call button on said control section as to whether said call button is pressed while the incoming record data is displayed; and
call back means for calling a telephone number provided as a call address in the incoming record data displayed when said call button is pressed.

3. The telephone apparatus of claim 1, wherein said controller further comprises:
means for determining actuation of a text message incoming record perusal mode button on said control section, as to whether said record perusal mode button is pressed;
means for determining actuation of an incoming record search button on said control section, as to whether said incoming record search button is pressed; and
incoming record search means for determining presence or absence of an incoming record data when said record perusal mode button and said incoming record search button are determined pressed.

4. A telephone apparatus having a function of communicating a text message via a phone-line interface, said telephone apparatus comprising:
said phone-line interface in connection with public telephone network;
a text message incoming record storage for storing a text message received via said phone-line interface and a telephone number corresponding to the received text message as incoming record data in connection with a retrieval number used for retrieving the incoming record data;
a control section for entry of data input;
a display device; and
incoming record search means for determining presence or absence of the incoming record data;
switching means for shifting to a text message incoming record perusal mode when the incoming record data is determined present in the determination of presence or absence of the incoming record data;
retrieval number setting means for setting the retrieval number in a sequential order in the text message incoming record perusal mode;
display means for displaying the text message and the telephone number as the incoming record data corresponding to the retrieval number set in the sequential order;
means for determining actuation of a call button on said control section as to whether said call button is pressed while the incoming record data is displayed; and
call back means for calling a telephone number provided as a call address in the incoming record data displayed when said call button is pressed.

5. The telephone apparatus of claim 4 further comprising:
means for determining actuation of a text message incoming record perusal mode button on said control section, as to whether said record perusal mode button is pressed;
means for determining actuation of an incoming record search button on said control section, as to whether said incoming record search button is pressed; and
incoming record search means for determining presence or absence of an incoming record data when said record perusal mode button and said incoming record search button are determined pressed.

6. A method of making telephone call using a telephone apparatus having a phone-line interface in connection with public telephone network, a text message incoming record storage for storing a text message received via said phone-line interface and a telephone number corresponding to the received text message as incoming record data corresponding thereto, a control section for entry of data input, and a display device,
said method comprising a step of making a callback by calling a telephone number provided as a call address corresponding to a selected one of the incoming record data when a call button is pressed while the selected one of the incoming record data is displayed in a text message incoming record perusal mode.

7. The method of making telephone call as in claim 6 further comprising the steps of:
searching through incoming record to determine presence or absence of the incoming record data;
shifting to a text message incoming record perusal mode when the incoming record data is determined present in said step of determining presence or absence of the incoming record data;
setting a retrieval number in a sequential order in the text message incoming record perusal mode;
displaying as the incoming record data, a text message and a telephone number corresponding to the retrieval number set in the sequential order;
determining whether the call button on the control section is pressed while the incoming record data is displayed; and
making a callback by calling the telephone number provided as a call address in the incoming record data in display when the call button is pressed.

8. The method of making telephone call as in claim 6 further comprising the steps of:
determining whether a text message incoming record perusal mode button on the control section is pressed;
determining whether an incoming record search button on the control section is pressed; and
searching through incoming record to determine presence or absence of the incoming record data when the text message incoming record perusal mode button and the incoming record search button are pressed.

9. A computer-readable recording medium having a program recorded to make a computer execute a process of making telephone call with a telephone apparatus having a phone-line interface in connection with public telephone network, a text message incoming record storage for storing a text message received via said phone-line interface and a telephone number corresponding to the received text message as incoming record data corresponding thereto, a control section for entry of data input, and a display device,
said program comprising a step of making a callback by calling a telephone number provided as a call address corresponding to a selected one of the incoming record data when a call button is pressed while the selected one of the incoming record data is displayed in a text message incoming record perusal mode.

10. The computer-readable recording medium having the program as in claim 9, wherein said program further comprises the steps of:
searching through incoming record to determine presence or absence of the incoming record data;
shifting to a text message incoming record perusal mode when the incoming record data is determined present in said step of determining presence or absence of the incoming record data;
setting a retrieval number in a sequential order in the text message incoming record perusal mode;
displaying as the incoming record data, a text message and a telephone number corresponding to the retrieval number set in the sequential order;
determining whether the call button on the control section is pressed while the incoming record data is displayed; and
making a callback by calling the telephone number provided as a call address in the incoming record data in display when the call button is pressed.

11. The computer-readable recording medium having the program as in claim 9, wherein said program further comprises the steps of:
determining whether a text message incoming record perusal mode button on the control section is pressed;
determining whether an incoming record search button on the control section is pressed; and
searching through incoming record to determine presence or absence of the incoming record data when the text message incoming record perusal mode button and the incoming record search button are pressed.

12. A telephone apparatus having a function of communicating a text message via a phone-line interface, said telephone apparatus comprising:
said phone-line interface in connection with public telephone network;
a incoming-call record storage for storing a caller's identification data received via said phone-line interface as incoming-call record data;
a control section for entry of data input;
a display device; and
a controller,
wherein said controller sets the caller's identification data shown in the incoming-call record data as a forwarding address when incoming record search button on the control section is pressed after completion of inputting a text message in a text message transmission mode, and transmits the text message to the forwarding address.

13. The telephone apparatus of claim 12, wherein said controller further comprises:
means for determining actuation of an incoming record search button on said control section as to whether said incoming record search button is pressed after completion of inputting the text message in the text message transmission mode;
incoming record search means for searching an incoming-call record data when said incoming record search button is pressed;
display means for displaying said caller's identification data being searched in a sequential order;
means for determining actuation of a call button on said control section, as to whether said call button is pressed;
address setting means for setting the caller's identification data shown in the incoming-call record data as the forwarding address when said call button is pressed; and
transmission means for transmitting the text message to the forwarding address of the caller's identification data set thereto.

14. The telephone apparatus of claim 12, wherein said controller further comprises:
means for determining actuation of a text message transmission mode button on said control section, as to whether said text message transmission mode button is pressed;
switching means for shifting to the text message transmission mode when said transmission button is pressed; and
means for determining completion of input as to whether entry of the text message is completed in the text message transmission mode.

15. The telephone apparatus of claim 12, wherein said controller further comprises:
means for determining actuation of an incoming record search button on said control section as to whether said incoming record search button is pressed after completion of inputting a text message in the text message transmission mode;
means for determining actuation of a telephone directory search button as to whether said telephone directory search button is pressed; and
telephone directory processing means for retrieving a selected telephone directory data when said telephone directory search button is pressed, and transmitting the text message to a telephone number shown in the selected telephone directory data.

16. A telephone apparatus having a function of communicating a text message via a phone-line interface, said telephone apparatus comprising:
said phone-line interface in connection with public telephone network;
a incoming-call record storage for storing a caller's identification data received via said phone-line interface as incoming-call record data;
a control section for entry of data input;
a display device;
means for determining actuation of an incoming record search button on said control section, as to whether said incoming record search button is pressed after completion of inputting the text message in a text message transmission mode;
incoming record search means for searching an incoming-call record data when said incoming record search button is pressed;
display means for displaying said caller's identification data being searched in a sequential order;
means for determining actuation of a call button on said control section, as to whether said call button is pressed;
address setting means for setting the caller's identification data shown in the incoming-call record data as a forwarding address when said call button is pressed; and
transmission means for transmitting the text message to the forwarding address of the caller's identification data set thereto.

17. The telephone apparatus of claim 16 further comprising:
means for determining actuation of a text message transmission mode button on said control section, as to whether said text message transmission mode button is pressed;
switching means for shifting to the text message transmission mode when said transmission button is pressed; and
means for determining completion of input as to whether entry of the text message is completed in the text message transmission mode.

18. The telephone apparatus of claim 16 further comprising:
means for determining actuation of a telephone directory search button as to whether said telephone directory search button is pressed; and
telephone directory processing means for retrieving a selected telephone directory data when said telephone directory search button is pressed, and transmitting the text message to a telephone number shown in the selected telephone directory data.

19. A telephone apparatus having a function of communicating a text message via a phone-line interface, said telephone apparatus comprising:
said phone-line interface in connection with public telephone network;
a storage unit;
a display device; and
a controller,
wherein said storage unit comprises a text message incoming record storage and a incoming-call record storage, and further wherein
said text message incoming record storage stores a text message received via said phone-line interface and a telephone number corresponding to the received text message as incoming record data corresponding thereto,
said incoming-call record storage stores a caller's identification data received via said phone-line interface as incoming-call record data,
said controller makes a call to a telephone number corresponding to a selected incoming record data as a call address while the selected one of the incoming record data is displayed in a text message incoming record perusal mode, and
said controller sets the caller's identification data shown in the incoming-call record data as a forwarding address when incoming record search button on a control section is pressed after completion of inputting a text message in a text message transmission mode, and transmits the text message to the forwarding address.

20. A method of making telephone call with a telephone apparatus having a phone-line interface in connection with public telephone network, a incoming-call record storage for storing a caller's identification data received via the phone-line interface as incoming-call record data, a control section for entry of data input, and a display device,
said method comprising the steps of:
searching for an incoming-call record data when an incoming record search button on the control section is pressed after completion of inputting a text message in a text message transmission mode;
setting the caller's identification data shown in the incoming-call record data as a forwarding address; and
transmitting the text message to the forwarding address of the caller's identification data set thereto.

21. The method of making telephone call as in claim 20 further comprising the steps of:
determining actuation of the incoming record search button on the control section, as to whether the incoming record search button is pressed after completion of inputting the text message in the text message transmission mode;
searching for the incoming-call record data when the incoming record search button is pressed;
displaying the caller's identification data being searched in a sequential order;
determining actuation of a call button on the control section as to whether the call button is pressed when a desired caller's identification data is present among the data displayed;
setting the caller's identification data shown in the incoming-call record data as the forwarding address when the call button is pressed; and
transmitting the text message to the forwarding address of the caller's identification data set thereto.

22. The method of making telephone call as in claim 20 further comprising the steps of:
determining actuation of a text message transmission mode button on the control section as to whether the text message transmission mode button is pressed;
shifting to the text message transmission mode when the text message transmission mode button is pressed; and
determining completion of input as to whether entry of the text message is completed in the text message transmission mode.

23. The method of making telephone call as in claim 20 further comprising the steps of:
determining actuation of a telephone directory search button as to whether the telephone directory search button is pressed; and
retrieving a selected one of telephone directory data when the telephone directory search button is pressed, and transmitting the text message to a telephone number shown in the selected one of the telephone directory data.

24. A computer-readable recording medium having a program recorded to make a computer execute a process of making telephone call with a telephone apparatus having a phone-line interface in connection with public telephone network, a incoming-call record storage for storing a caller's identification data received via said phone-line interface as incoming-call record data, a control section for entry of data input, and a display device,
said program comprising the steps of:
searching for an incoming-call record data when an incoming record search button on the control section is pressed after completion of inputting a text message in a text message transmission mode;
setting the caller's identification data shown in the incoming-call record data as a forwarding address; and
transmitting the text message to the forwarding address of the caller's identification data set thereto.

25. The computer-readable recording medium having the program as in claim 24, wherein said program further comprises the steps of:
determining actuation of the incoming record search button on the control section, as to whether the incoming record search button is pressed after completion of inputting the text message in the text message transmission mode;
searching through incoming-call record data when the incoming record search button is pressed;
displaying the caller's identification data being searched in a sequential order;
determining actuation of a call button on the control section, as to whether the call button is pressed when a desired caller's identification data is present among the data displayed;
setting the caller's identification data shown in the incoming-call record data as the forwarding address when the call button is pressed; and
transmitting the text message to the forwarding address of the caller's identification data set thereto.

26. The computer-readable recording medium having the program as in claim 24, wherein said program further comprises the steps of:
determining actuation of a text message transmission mode button on the control section, as to whether the text message transmission mode button is pressed;
shifting to the text message transmission mode when the text message transmission mode button is pressed; and
determining completion of input as to whether entry of the text message is completed in the text message transmission mode.

27. The method of making a telephone call as in claim 24 further comprising the steps of:
determining actuation of a telephone directory search button as to whether the telephone directory search button is pressed; and
retrieving a selected one of telephone directory data when the telephone directory search button is pressed, and transmitting the text message to a telephone number shown in the selected one of the telephone directory data.
